(19) United States
(12) Patent Application Publication
(10) Pub. No.: US 2025/0234332 A1
(43) Pub. Date: Jul. 17, 2025

(54) METHOD AND APPARATUS FOR TRANSMITTING INFORMATION, COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/703,250

(22) PCT Filed: Oct. 21, 2021
(86) PCT No.: PCT/CN2021/125447

§ 371 Date: Apr. 19, 2024

(51) Int. Cl. H04W 68/02; H04W 24/08; H04W 76/20

(52) U.S. Cl. CPC H04W 68/02; H04W 24/08; H04W 76/20

(57) ABSTRACT

A methods, apparatus and computer readable medium for enhancing the network's efficiency by optimizing the synchronization between the base station's transmission schedules and the network's operational parameters. The efficacy of the wireless network is enhanced by: a base station transmitting information regarding the placement of paging time window (PTW) start points within a hyper frame to facilitate network communications. Specifically, it sends indication information that specifies an “N value,” which represents the number of potential PTW start positions, either for the radio access network (RAN) or the core network (CN) components of a hyper frame.

### CROSS REFERENCE TO RELATED APPLICATION

The present application is the U.S. National Stage Application of International Application No. PCT/CN2021/125447 filed on Oct. 21, 2021, the entire content of which is incorporated herein by reference for all purposes.

### BACKGROUND

A 5th generation (5G) cellular mobile communication network utilizes an extended discontinuous reception mechanism to further reduce energy consumption of a terminal.

### SUMMARY

The disclosure relates to, but is not limited to the technical field of wireless communication, in particular to a method for transmitting information and apparatus, a communication device, and a storage medium.

According to a first aspect of the examples of the disclosure, a method for transmitting information is provided, performed by a first base station, and including:
sending indication information indicating an N value, where the N value is a number of candidate positions of PTW start point of a hyper frame.

According to a second aspect of the examples of the disclosure, a method for determining paging parameter is provided, performed by user equipment (UE), and including:

receiving indication information indicating an N value, where the N value is a number of candidate positions of PTW start point of a hyper frame.

According to a third aspect of the examples of the disclosure, a method for transmitting information is provided, performed by a core network, and including:
sending indication information indicating an N value, where the N value is a number of candidate positions of core network (CN) PTW start point of a hyper frame.

According to a fourth aspect of the examples of the disclosure, an apparatus for transmitting information is provided, including:
a first sending module, configured to send indication information indicating an N value, where the N value is a number of candidate positions of PTW start point of a hyper frame.

According to a fifth aspect of the examples of the disclosure, an apparatus for use in a UE is provided, including:
one or more processors; and
a memory configured to store an instruction executable by the processor;
where the one or more processors are collectively configured to load and execute the instruction, wherein the instruction causes the one or more processors to collectively execute the method for determining paging parameter according to the second aspect.

According to a sixth aspect of the examples of the disclosure, an apparatus for transmitting information is provided, including:
a third sending module, configured to send indication information indicating an N value, where the N value is a number of candidate positions of core network (CN) PTW start point of a hyper frame.

According to a seventh aspect of the examples of the disclosure, a communication device for use in a first base station is provided, including: one or more processors; a memory; and an executable program stored on the memory; where the executable program when executed by the one or more processors cause the one or more processors to collectively execute the method for transmitting information according to the first aspect.

According to an eighth aspect of the examples of the disclosure, a non-transitory computer-readable storage medium is provided, storing an executable program, where the executable program, when executed by a processor, implements the method for transmitting information according to the first aspect.

It is to be understood that the general description above and the following detailed description are illustrative and explanatory, and do not limit the examples of the disclosure.

### BRIEF DESCRIPTION OF DRAWINGS

Accompanying drawings here are incorporated into the specification and form a part of the specification, and show principles consistent with the examples of the disclosure and used to explain the examples of the disclosure with the specification.

FIG. 1 is a schematic structural diagram of a wireless communication system shown according to an example.

FIG. 2 is a schematic flow diagram of a method for transmitting information shown according to an example.

FIG. 3 is a schematic flow diagram of a method for determining paging parameter shown according to an example.

FIG. 4 is a schematic flow diagram of another method for transmitting information shown according to an example.

FIG. 5 is a schematic flow diagram of yet another method for transmitting information shown according to an example.

FIG. 6 is a schematic flow diagram of another method for determining paging parameter shown according to an example.

FIG. 7 is a schematic flow diagram of yet another method for transmitting information shown according to an example.

FIG. 8 is a block diagram of an apparatus for transmitting information shown according to an example.

FIG. 9 is a block diagram of an apparatus for determining paging parameter shown according to an example.

FIG. 10 is a block diagram of another an apparatus for transmitting information shown according to an example.

FIG. 11 is a block diagram of an apparatus for determining paging parameter or transmitting information shown according to an example.

### DETAILED DESCRIPTION

Within each eDRX period, merely within a set paging time window (PTW), the terminal may receive downlink data, and is in a dormant state and does not receive the downlink data for the rest of time, and the eDRX mechanism may achieve an equilibrium between a downlink service delay and power consumption. For example, the eDRX mechanism may be used for remote gas switch control.

In view of this, examples of the disclosure provide a method for transmitting information and apparatus, a communication device, and a storage medium.

Examples will be described in detail here, as illustrated in accompanying drawings. In response to determining that the description below refers to the accompanying drawings, unless otherwise indicated, the same numbers in different accompanying drawings indicate the same or similar elements. Implementations described in the following examples do not represent all implementations consistent with the examples of the disclosure. Rather, the examples are merely examples of apparatuses and methods that are consistent with some aspects of the examples of the disclosure as detailed in the appended claims.

Terms used in the examples of the disclosure are intended to describe specific examples, and are not intended to limit the examples of the disclosure. The singular forms “a/an,” “said,” and “the” as used in the examples of the disclosure and the appended claims are also intended to include plural forms, unless the context clearly indicates otherwise. It is to be further understood that the terms “and/or” used in the context refers to and contains any or all possible combinations of one or more associated listed items.

It is to be understood that although the terms first, second, third, etc. may be adopted to describe various information in the examples of the disclosure, such information is not limited to these terms. These terms are configured to distinguish the same type of information from each other. For example, within the scope of the examples of the disclosure, first information may also be called second information, and similarly, the second information may also be called the first information. Depending on the context, the word “if” used here may be explained as “on . . . when,” “when” or “in response to determining.”

Please refer to FIG. 1, a schematic structural diagram of a wireless communication system provided by an example of the disclosure is shown. As shown in FIG. 1, the wireless communication system is a communication system based on a cellular mobile communication technology, and the wireless communication system may include a plurality of terminals 11 and a plurality of base stations 12.

The terminals 11 may be devices for providing voice and/or data connectivity for a user. The terminals 11 may communicate with one or more core networks through a radio access network (RAN), the terminals 11 may be Internet of Things terminals, such as a sensor device, a mobile phone (or called a “cellular” phone) and a computer having Internet of Things terminals, for example, may be a fixed apparatus, a portable apparatus, a pocket apparatus, a handheld apparatus, a computer built-in apparatus or a vehicle-mounted apparatus, such as a station (STA), a subscriber unit, a subscriber station, a mobile station, a mobile, a remote station, an access point, a remote terminal, an access terminal, a user terminal, a user agent, a user device, or user equipment (UE). Or, the terminals 11 may also be devices of unmanned aerial vehicles. Or, the terminals 11 may also be vehicle-mounted devices, for example, may be travelling computers with a wireless communication function, or wireless communication devices externally connected to the travelling computers. Or, the terminals 11 may also be roadside devices infrastructure, for example, may be street lamps, signal lamps or other roadside devices with wireless communication functions.

The base stations 12 may be network side devices in the wireless communication system. The wireless communication system may be the 4th generation mobile communication (4G) system, also called a long term evolution (LTE) system; or, the wireless communication system may also be a 5G system, also called a new radio (NR) system or a 5G NR system. Or, the wireless communication system may also be a next generation system of the 5G system. An access network of the 5G system may be called a new generation-radio access network (NG-RAN). Or, the wireless communication system may be an MTC system.

The base stations 12 may be evolved base stations (eNB) adopted in the 4G system. Or, the base stations 12 may also be base stations (gNB) adopting a concentrated distributed architecture in the 5G system. In response to determining that the base stations 12 adopt the concentrated distributed architecture, the base stations 12 generally include a central unit (CU) and at least two distributed units (DUs). Protocol stacks of a packet data convergence protocol (PDCP) layer, a radio link control (RLC) layer, and a media access control (MAC) layer are arranged in the central unit; and protocol stacks of a physical (PHY) layer are arranged in the distributed units. The specific implementation of the base stations 12 is not limited in the example of the disclosure.

Wireless connection may be established between the base stations 12 and the terminals 11 through a wireless air interface. In different implementations, the wireless air interface is a wireless air interface based on the 4th generation mobile communication network technology (4G) standard; or, the wireless air interface is a wireless air interface based on the 5th generation mobile communication network technology (5G) technical standard, for example, the wireless air interface is the new radio; or, the wireless air interface may also be a wireless air interface based on the next generation mobile communication network technology standard of 5G.

In some examples, end to end (E2E) connection may further be established between the terminals 11, such as vehicle to vehicle (V2V) communication, vehicle to infrastructure (V2I) communication and vehicle to pedestrian (V2P) communication and other scenes in vehicle to everything (V2X) communication.

In some examples, the above wireless communication system may further include a network management device 13.

The plurality of base stations 12 are respectively connected with the network management device 13. The network management device 13 may be a core network device in the wireless communication system, for example, the network management device 13 may be a mobility management entity (MME) in an evolved packet core (EPC). Or, the network management device may also be other core network devices, such as a serving gateway (SGW), a public data network gateway (PGW), a policy and charging rules function (PCRF) or a home subscriber server (HSS). The example of the disclosure does not limit the implementation form of the network management device 13.

An executive body involved in the example of the disclosure includes but is not limited to UE such as a phone terminal supporting cellular mobile communication, the base stations, the core networks and the like.

In the related art, an eDRX period TeDRX, H decides a hyper frame (HSFN) where a PTW is located, and the HSFN where the PTW is located needs to meet an expression (1).

$$HSFN mod {T}_{e DRX , H} = ( UE\_ID \_H mod {T}_{e D R X , H} ) \qquad ( 1 )$$

UE_ID_H is a plurality of most significant bits of a UE hashed identification (Hashed ID).

In one HSFN, four candidate positions will decide a start point of the PTW (PTW_start), and an SFN where the PTW_start is located may be determined according to expressions (2) and (3):

$$SFN = 1024 / 4 * {i}_{e D R X} \qquad ( 2 )$$

$${i}_{e D R X} = floor ( UE\_ID \_H / {T}_{e D R X , H} ) mod 4 \qquad ( 3 )$$

The number of the candidate positions of PTW start point of a hyper frame is fixed to be 4, which cannot be configured, cannot meet the communication technology development, and cannot meet selection demands of different types of UE on the PTW. As such, how to implement the configuration of the number of the candidate positions of PTW start point of the hyper frame, meet the communication technology development, and meet the selection demands of different types of UE on the candidate positions of the PTW start point is an urgent problem to be solved.

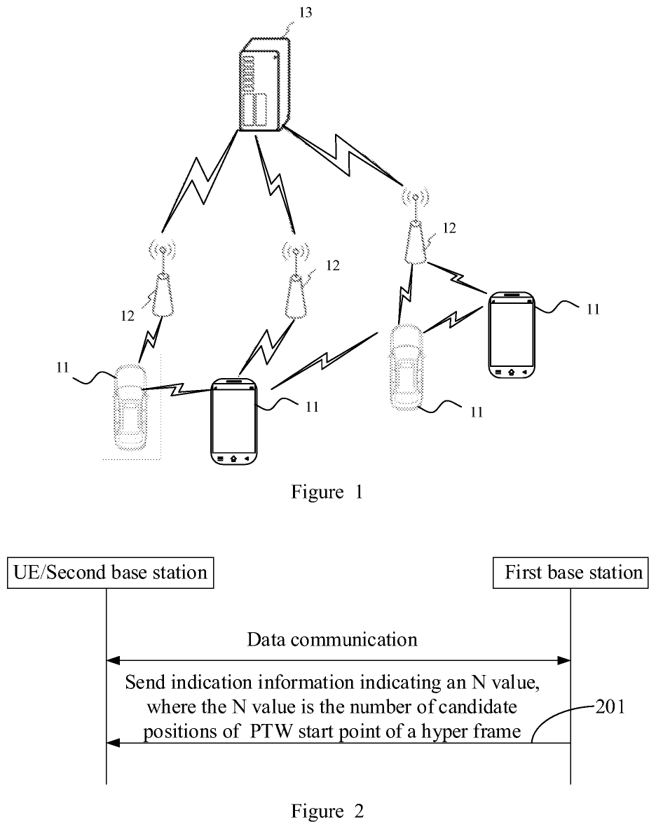

As shown in FIG. 2, an example provides a method for transmitting information. The method for transmitting information may be performed by a first base station of a cellular mobile communication system, and includes:

step 201: indication information indicating an N value is sent, where the N value is the number of candidate positions of PTW start point of a hyper frame.

Here, the N value may be determined by a core network, a base station, etc. in the cellular mobile communication system, and the N value may include but is not limited to: 4, 6 or 8 or 16, etc. The N value may be determined based on power saving demands of UE and sending demands of a paging message in a cellular mobile communication process.

The first base station may send the indication information indicating the N value to the UE. The first base station may also send the indication information indicating the N value to other base stations. In response to determining that the N value is determined by the core network, the core network may indicate the N value to the first base station, and then the N value is sent by the first base station.

Here, the first base station may be a base station connected with the UE, or an anchor base station when the UE is in a non-activated state. The UE or other base stations may determine the number of the candidate positions of PTW start point of the hyper frame according to the indication information, and then determine the SFN where the PTW start point (PTW_start) is located.

For example, the SFN where the PTW_start is located may be determined by adopting a way similar to the related art. For example, the N value may be adopted to replace “4” in the expressions (2) and (3), so as to obtain a new expression, and the SFN where the PTW_start is located is determined through the new expression.

As such, the first base station sends the indication information to indicate the N value of the number of the candidate positions of PTW start point of the hyper frame, and the first base station may flexibly configure the N value, which is no longer limited to a fixed value, and may meet different demands on the number of the candidate positions of the PTW start point.

In an example, the N value includes at least one of:
a first N value, being the number of candidate positions of radio access network (RAN) PTW start point of a hyper frame; or
a second N value, being the number of candidate positions of core network (CN) PTW start point of a hyper frame.

Here, the PTW includes: the RAN PTW and/or the CN PTW. The core network may send a CN paging message in the CN PTW, and the base station may send an RAN paging message in the RAN PTW.

The first base station may send the indication information indicating the first N value to the UE or other base stations, may also send the indication information indicating the second N value to the UE or other base stations, and may further send the indication information indicating the first N value and the second N value to the UE or other base stations.

By indicating the first N value and/or the second N value, different demands on the candidate positions of the RAN PTW start point and/or the candidate positions of the CN PTW start point may be respectively met.

In an example, sending the indication information indicating the N value includes at least one of:
sending the indication information to the user equipment (UE); or
sending the indication information to a second base station, where the second base station includes adjacent base station(s) of the first base station.

Here, the first base station may be a service base station of the UE, and the first base station may also be the anchor base station of the UE in the non-activated state.

For example, the first base station sends the indication information indicating the first N value to the UE, and the UE may determine the number of the candidate positions of RAN PTW start point of the hyper frame based on the indication information, and then determine configurations such as the PTW_start of the RAN PTW.

The first base station may also send the indication information indicating the second N value to the UE, and the UE may determine the number of the candidate positions of CN PTW start point of the hyper frame based on the indication information, and then determine configurations such as the PTW_start of the CN PTW. In this case, the core network sends the indication information indicating the number (namely, the second N value) of the candidate positions of CN PTW start point of the hyper frame to the first base station, and in response to determining that the indication information is received, the first base station will use the indication information for subsequent scheduling of UE paging messages.

In an example, the indication information is carried in a radio resource control (RRC) message or a system message.

Here, the indication information indicating the N value may be carried in the RRC message and sent to the UE. Here, the RRC message includes but is not limited to an RRC release message and the like. The UE may determine the N value according to the indication information carried in the RRC message.

For example, in response to determining that the indication information indicating the N value sent by the base station aims at the single UE, the indication information is carried through the RRC message and sent to the UE.

The system message may include a system information block (SIB) and the like.

For example, in response to determining that the indication information indicating the N value sent by the base station aims at all the UE in a cell, the indication information may be carried through the system message, and the system message is broadcast in the cell. The UE in the cell may determine the N value according to the indication information carried in the system message.

The first base station may also be the anchor base station of the UE in the non-activated state, and the second base station may be a non-anchor base station of the UE in the non-activated state. The UE determines the PTW based on the N value sent by the anchor base station, as such, the anchor base station may send the N value for the UE to the non-anchor base station, for the non-anchor base station to determine the PTW, and page the UE in the PTW. The second base station may be adjacent to the first base station.

In an example, the indication information is carried in the radio access network paging message and sent to the second base station.

For example, the anchor base station may carry the indication information indicating the N value in the radio access network paging message and send the same to the second base station, such as the non-anchor base station. The second base station may directly determine the PTW according to the N value in the radio access network paging message, and page the UE in the PTW.

The indication information is carried in the radio access network paging message and sent to the second base station, the first base station does not additionally send information to indicate the N value, and the second base station directly determines the N value from the radio access network paging message, which improves the efficiency of indicating the N value and sending the paging message to the UE.

In an example, the method further includes:
receiving auxiliary information sent by the UE; and
determining the N value based on the auxiliary information;
the auxiliary information includes:

first information for the first base station to determine the number of the candidate positions of RAN PTW start point of the hyper frame;
and/or,
second information for the core network to determine the number of the candidate positions of CN PTW start point of the hyper frame.

Here, the auxiliary information may include capacity information of the UE, type information of the UE and the like. The capacity information of the UE may indicate the capacity of the UE to monitor the PTW, and the first base station or the core network may determine the N value based on the capacity information of the UE. For example, the capacity information of the UE indicates that the UE has the capacity to monitor at eight PTW start point positions, so the N value may be set as 8. The type information of the UE may indicate type of the UE, and different types of UE have different PTW monitoring capacities, so that the first base station or the core network may determine the N value based on the type of the UE.

In an example, the method further includes:
receiving the indication information indicating the number of the candidate positions of CN PTW start point of the hyper frame sent by the core network.

The number of the candidate positions of CN PTW start point of the hyper frame is the second N value which may be determined by the core network. The core network may send the determined number of the candidate positions of CN PTW start point of the hyper frame to the base station through the indication information. The base station may send the indication information indicating the number of the candidate positions of CN PTW start point of the hyper frame to the UE or other base stations, and/or the base station may retain the number of the candidate positions of CN PTW start point of the hyper frame for subsequent scheduling use.

In an example, the method further includes:
determining, in response to determining that the indication information indicating the number of the candidate positions of CN PTW start point of the hyper frame sent by the core network is not received, the number of the candidate positions of CN PTW start point of the hyper frame according to a first preset value.

The number of the candidate positions of CN PTW start point of the hyper frame may be configured with the first preset value, and the first preset value may be 4 and the like. Taking 4 as the first preset value may increase the compatibility with the related art.

In response to determining that the core network does not send the indication information indicating the number of the candidate positions of CN PTW start point of the hyper frame, the base station may adopt the first preset value to configure the number of the candidate positions of CN PTW start point of the hyper frame.

For example, in response to determining that the base station may adopt the first preset value to configure the number of the candidate positions of CN PTW start point of the hyper frame, the base station may indicate the number of the candidate positions of CN PTW start point of the hyper frame to the UE through the indication information, that is, the first preset value; or the base station may also not perform indication, and the UE autonomously adopts the first preset value to configure the number of the candidate positions of CN PTW start point of the hyper frame.

In an example, sending the indication information to the UE includes at least one of:
sending, based on indication of the core network, the indication information for the single UE; or
sending, based on the indication of the core network, the indication information for all the UE in a cell.

The core network may indicate the base station to send the indication information for the single UE or send the indication information for all the UE in the cell through an explicit indication way.

For example, the core network may indicate to send the indication information for the single UE or send the indication information for all the UE in the cell through one or more bits in a signaling sent to the base station. The core network may indicate by using one bit, using “1” to indicate to send the indication information for the single UE, and using “0” to indicate to send the indication information for all the UE in the cell.

The core network may indicate the base station to send the indication information for the single UE or send the indication information for all the UE in the cell through an implicit indication way. The indication information may be carried in different messages, and the different messages may respectively indicate to send the indication information for the single UE or send the indication information for all the UE in the cell.

In an example, sending, based on the indication of the core network, the indication information for the single UE includes:
sending, in response to determining that the paging message carrying the indication information indicating the N value sent by the core network is received, the indication information to the UE paged by the paging message.

For example, the core network may carry the indication information indicating the N value in the paging message, carrying the indication information indicating the N value in the paging message may imply indicating to send the indication information for the single UE, and after receiving the paging message, the base station may forward the paging message to the paged UE.

In an example, sending, based on the indication of the core network, the indication information for all the UE in the cell includes:
sending, in response to determining that an NG setup response message carrying the indication information indicating the N value sent by the core network is received, the indication information for all the UE in the cell or retaining the N value for the subsequent paging scheduling of a terminal.

The core network may carry the indication information indicating the N value in the NG setup response message, carrying the indication information indicating the N value in the NG setup response message may imply indicating to send the indication information for all the UE in the cell, and after receiving the NG setup response message, the base station may send the indication information indicating the N value to all the UE in the cell. For example, the base station may carry the indication information in the system message to broadcast all the UE in the cell. Here, the NG setup response message is used for information communication of initial cells during establishing. In other instances, after the base station receives the NG setup response message, the N value is preserved and used for paging message scheduling.

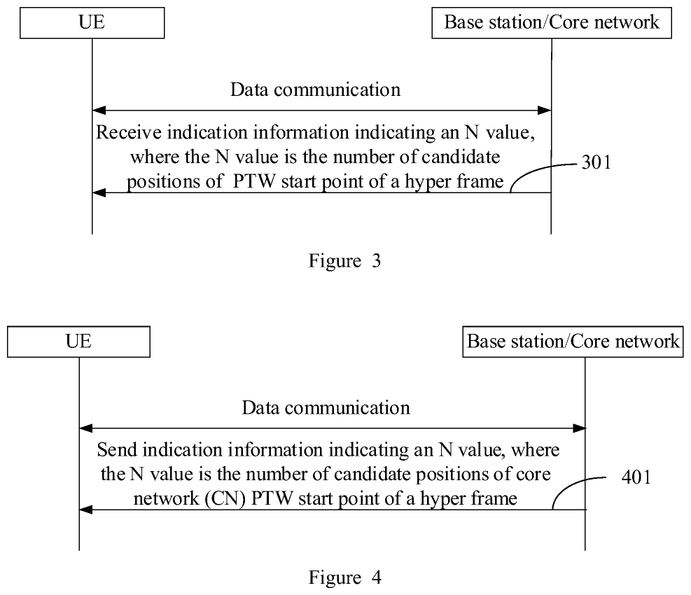

As shown in FIG. 3, an example provides a method for determining paging parameter. The method for determining paging parameter may be performed by UE of a cellular mobile communication system, and includes:

step 301: indication information indicating an N value is received, where the N value is the number of candidate positions of PTW start point of a hyper frame.

Here, the N value may be determined by the core network, the base station, etc. in the cellular mobile communication system, and may include but is not limited to: 4, 6 or 8 or 16, etc. The N value may be determined based on power saving demands of the UE and sending demands of a paging message in a cellular mobile communication process.

The indication information indicating the N value may be sent by the base station, or sent by the core network.

Here, the base station may be a base station connected with the UE, or an anchor base station when the UE is in a non-activated state. The UE may determine the number of candidate positions of PTW start point of a hyper frame based on the indication information, and then determine an SFN where a PTW start point (PTW_start) is located.

For example, the UE may determine the SFN where the PTW_start is located by adopting a way similar to the related art. For example, the N value may be adopted to replace “4” in the expressions (2) and (3), so as to obtain a new expression, and the SFN where the PTW_start is located is determined through the new expression.

As such, the number of the candidate positions of PTW start point of the hyper frame no longer adopts a fixed value, is determined according to the received indication information, which increases the flexibility of determining the PTW start point, and different demands on the number of the candidate positions of the PTW start point may be met.

In an example, the N value includes at least one of:
a first N value, being the number of candidate positions of radio access network (RAN) PTW start point of the hyper frame; or
a second N value, being the number of candidate positions of core network (CN) PTW start point of the hyper frame.

Here, the PTW includes: an RAN PTW and/or a CN PTW. The core network may send a CN paging message in the CN PTW, and the base station may send an RAN paging message in the RAN PTW.

By indicating the first N value and/or the second N value, the UE may respectively determine the RAN PTW start point and/or the CN PTW start point, and will not be limited to a fixed value to determine the RAN PTW start point and/or the CN PTW start point. The flexibility of determining the PTW start point is increased.

In an example, receiving the indication information indicating the N value includes at least one of:
receiving the indication information sent by a first base station; or
receiving the indication information sent by the core network.

The number of the candidate positions of radio access network (RAN) PTW start point of the hyper frame, namely, the first N value, is usually determined by the base station, as such, in response to determining that the base station needs to indicate the first N value to the UE, the base station may directly send the indication information to the UE.

The number of the candidate positions of core network (CN) PTW start point of the hyper frame, namely, the second N value, is usually determined by the core network, as such, in response to determining that the core network needs to indicate the second N value to the UE, the core network may directly send the indication information to the UE through a transparent transmission way; or the base station may forward and carry the indication information indicating the second N value.

In an example, the indication information is carried in a radio resource control (RRC) message, a system message, a non-access-stratum (NAS) signaling, or a paging message.

Here, the indication information indicating the N value may be carried in the RRC message and sent to the UE by the base station. Here, the RRC message includes but is not limited to an RRC release message and the like. The UE may determine the N value according to the indication information carried in the RRC message.

For example, in response to determining that the indication information indicating the N value sent by the base station aims at the single UE, the indication information is carried through the RRC message and sent to the UE. Here, the indication information carried in the RRC message may indicate the first N value and/or the second N value.

The system message may include a system information block (SIB) and the like.

For example, in response to determining that the indication information indicating the N value sent by the base station aims at all the UE in the cell, the indication information is carried through the system message, and the system message is broadcast in the cell. The UE in the cell may determine the N value according to the indication information carried in the system message. Here, the indication information carried in the system message may indicate the first N value and/or the second N value.

In response to determining that the core network needs to directly send the indication information indicating the N value to the UE, the NAS signaling may be adopted, and the indication information is carried in the NAS signaling and sent to the UE.

For example, in response to determining that the core network needs to indicate the number of the candidate positions of core network (CN) PTW start point of the hyper frame to the UE, namely, the second N value, the core network may carry the indication information through the NAS signaling and send the same to the UE.

Here, the paging message may include a CN paging message and/or an RAN paging message.

For example, the core network may carry the indication information in the CN paging message and send the same to the UE. The base station may carry the indication information in the RAN paging message and send the same to the UE. Here, the indication information carried in the RAN paging message may indicate the first N value and/or the second N value, where the second N value may be sent to the base station by the core network.

In an example, the method further includes at least one of:
determining, in response to determining that the indication information is not received, the number of the candidate positions of CN PTW start point of the hyper frame according to a first preset value;
determining, in response to determining that the indication information is not received, the number of the candidate positions of RAN PTW start point of the hyper frame according to a second preset value; or
determining, in response to determining that the indication information is not received, the number of the candidate positions of RAN PTW start point of the hyper frame according to the number of the candidate positions of CN PTW start point of the hyper frame.

The number of the candidate positions of CN PTW start point of the hyper frame may be configured with the first preset value, and the first preset value may be 4. Taking 4 as the first preset value may improve the compatibility with the related art.

In response to determining that the core network does not send the indication information indicating the number of the candidate positions of CN PTW start point of the hyper frame, or, the base station does not send the indication information indicating the number of the candidate positions of CN PTW start point of the hyper frame, the UE may adopt the first preset value to configure the number of the candidate positions of CN PTW start point of the hyper frame.

The number of the candidate positions of RAN PTW start point of the hyper frame may be configured with the second preset value, and the second preset value may be 4. Taking 4 as the second preset value may improve the compatibility with the related art.

In response to determining that the base station does not send the indication information indicating the number of the candidate positions of RAN PTW start point of the hyper frame, the UE may adopt the second preset value to configure the number of the candidate positions of RAN PTW start point of the hyper frame.

In response to determining that the core network is configured with the number of the candidate positions of CN PTW start point of the hyper frame, and the base station does not send the indication information indicating the number of the candidate positions of RAN PTW start point of the hyper frame, the UE may determine the number of the candidate positions of CN PTW start point of the hyper frame as the number of the candidate positions of RAN PTW start point of the hyper frame.

In an example, the method further includes:
sending auxiliary information;
the auxiliary information includes:
first information for the first base station to determine the number of the candidate positions of RAN PTW start point of the hyper frame;
and/or,
second information for the core network to determine the number of the candidate positions of CN PTW start point of the hyper frame.

Here, the auxiliary information may include capacity information of the UE and type information of the UE. The capacity information of the UE may indicate the capacity of the UE to monitor the PTW, and the first base station or the core network may determine the N value based on the capacity information of the UE. For example, the capacity information of the UE indicates that the UE has the capacity to monitor at eight PTW start point positions, so the N value may be set as 8. The type information of the UE may indicate type of the UE, and different types of UE have different PTW monitoring capacities, so that the first base station or the core network may determine the N value based on the type of the UE.

For example, the UE may send the auxiliary information to the core network, and the core network determines the number of the candidate positions of CN PTW start point of the hyper frame. The UE may also send the auxiliary information to the base station, and the base station determines the number of the candidate positions of RAN PTW start point of the hyper frame.

In an example, the method further includes:
determining a position of the RAN PTW start point according to the number of the candidate positions of RAN PTW start point of the hyper frame and a non-activated state eDRX period.

For the UE in the non-activated state, the RAN may configure the non-activated state eDRX period for the UE in the non-activated state, for further reducing power consumption of the UE in the non-activated state. A duration of the non-activated state eDRX period may be smaller than a duration of an eDRX period configured by the core network. A duration value range of the non-activated state eDRX period may be {2.56 s, 5.12 s, 10.24 s and above 10.24 s}.

The base station may configure the position of the RAN PTW start point based on the number of the candidate positions of RAN PTW start point of the hyper frame and the non-activated state eDRX period. The UE determines the position of the RAN PTW start point based on the number of the candidate positions of RAN PTW start point of the hyper frame and the non-activated state eDRX period or an idle state eDRX period in the same way, so as to receive the paging message in the RAN PTW.

The UE may adopt a way similar to that for determining a position of the CN PTW start point to determine the position of the RAN PTW start point based on the number of the candidate positions of RAN PTW start point of the hyper frame and operation of the non-activated state eDRX period.

In an example, the method further includes:
monitoring, within an overlapping time period of the RAN PTW and the CN PTW, the RAN paging message and the CN paging message.

Since the non-activated state eDRX period may be not the same as the eDRX period, the number of the candidate positions of RAN PTW start point of the hyper frame may be not the same as the number of the candidate positions of CN PTW start point of the hyper frame. As such, the RAN PTW start point and the CN PTW start point may be the same or different.

Within the overlapping time period of the RAN PTW and the CN PTW, a paging occasion of the RAN paging message may exist, a paging occasion of the CN paging message may also exist, as such, the UE needs to simultaneously monitor the RAN paging message and the CN paging message within the overlapping time period of the RAN PTW and the CN PTW. At this time, a start point of paging motoring may be decided according to the CN PTW start point.

Within a non-overlapping time period of the RAN PTW and the CN PTW, monitoring of the RAN paging message and the CN paging message may be performed respectively, and at this time, the start point of paging motoring may be decided according to respective PTW start points.

As shown in FIG. 4, an example provides a method for transmitting information. The method for transmitting information may be performed by a core network of a cellular mobile communication system, and includes:

step 401: indication information indicating an N value is sent, where the N value is the number of candidate positions of core network (CN) PTW start point of a hyper frame.

Here, the N value may be determined by the core network of the cellular mobile communication system, and may include but is not limited to: 4, 6 or 8 or 16, etc. The N value may be determined based on power saving demands of the UE and sending demands of a paging message in a cellular mobile communication process.

The core network may directly send the indication information indicating the N value to the UE.

The core network may also send the indication information indicating the N value to a base station, etc. The base station may forward the indication information to the UE.

The UE or the base station may determine the number of the candidate positions of CN PTW start point of the hyper frame according to the indication information, and then determine an SFN where the CN PTW start point (PTW_start) is located.

For example, the SFN where the PTW_start is located may be determined by adopting a way similar to the related art. For example, the N value may be adopted to replace “4” in the expressions (2) and (3), so as to obtain a new expression, and the SFN where the PTW_start is located is determined through the new expression.

As such, the core network sends the indication information to indicate the N value of the number of the candidate positions of CN PTW start point of the hyper frame, the core network may flexibly configure the N value, which is no longer limited to a fixed value, and may meet different demands on the number of the candidate positions of the CN PTW start point.

In an example, sending the indication information indicating the N value includes at least one of:
sending the indication information to the user equipment (UE); or
sending the indication information to the base station.

The number of the candidate positions of core network (CN) PTW start point of the hyper frame is usually determined by the core network, as such, in response to determining that the core network needs to indicate the N value to the UE, the core network may directly send the indication information to the UE through a transparent transmission way; the core network may send the indication information indicating the N value to the base station; and the core network may also forward and carry the indication information indicating the N value by the base station.

In an example, the method further includes at least one of:
indicating, in response to sending the indication information to the base station, the base station to send the indication information for the single UE; or
indicating, in response to sending the indication information to the base station, the base station to send the indication information for all the UE in a cell.

The core network may indicate the base station to send the indication information for the single UE or send the indication information for all the UE in the cell through an explicit indication way.

For example, the core network may indicate to send the indication information for the single UE or send the indication information for all the UE in the cell through one or more bits in a signaling sent to the base station. The core network may indicate by using one bit, using “1” to indicate to send the indication information for the single UE, and using “0” to indicate to send the indication information for all the UE in the cell.

The core network may indicate the base station to send the indication information for the single UE or send the indication information for all the UE in the cell through an implicit indication way. The indication information may be carried in different messages, and the different messages may respectively indicate to send the indication information for the single UE or send the indication information for all the UE in the cell.

In an example, indicating the base station to send the indication information for the single UE includes:
sending a paging message for the UE to the base station, where the paging message carries the indication information.

For example, the core network may carry the indication information indicating the N value in the paging message, carrying the indication information indicating the N value in the paging message may imply indicating to send the indication information for the single UE, and after receiving the paging message, the base station may forward the paging message to the paged UE.

In an example, indicating the base station to send the indication information for all the UE in the cell includes:
sending an NG setup response message to the base station, where the NG setup response message carries the indication information.

The core network may carry the indication information indicating the N value in the NG setup response message, carrying the indication information indicating the N value in the NG setup response message may imply indicating to send the indication information for all the UE in the cell, and after receiving the NG setup response message, the base station may send the indication information indicating the N value to all the UE in the cell. For example, the base station may carry the indication information in the system message to broadcast all the UE in the cell. Here, the NG setup response message is used for information communication of initial cells during establishing.

In an example, the indication information is carried in a non-access-stratum (NAS) signaling, or the paging message.

In response to determining that the core network needs to directly send the indication information indicating the N value to the UE, the NAS signaling may be adopted, and the indication information is carried in the NAS signaling and sent to the UE.

For example, in response to determining that the core network needs to indicate the number of the candidate positions of core network (CN) PTW start point of the hyper frame to the UE, the core network may carry the indication information through the NAS signaling and send the same to the UE.

In response to determining that the core network needs to indicate the number of the candidate positions of core network (CN) PTW start point of the hyper frame to the UE, the core network may also carry the indication information through the paging message and send the same to the UE.

In an example, the method further includes:
receiving auxiliary information sent by the UE; and
determining the N value based on the auxiliary information.

Here, the auxiliary information may include capacity information of the UE, type information of the UE and the like. The capacity information of the UE may indicate the capacity of the UE to monitor the PTW, and the first base station or the core network may determine the N value based on the capacity information of the UE. For example, the capacity information of the UE indicates that the UE has the capacity to monitor at eight PTW start point positions, so the N value may be set as 8. The type information of the UE may indicate type of the UE, and different types of UE have different PTW monitoring capacities, so that the first base station or the core network may determine the N value based on the type of the UE.

For example, the UE may send the auxiliary information to the core network, and the core network determines the number of the candidate positions of CN PTW start point of the hyper frame. The UE may also send the auxiliary information to the base station, and the base station determines the number of the candidate positions of RAN PTW start point of the hyper frame.

Four examples are provided below in conjunction with any above example:

### Example 1

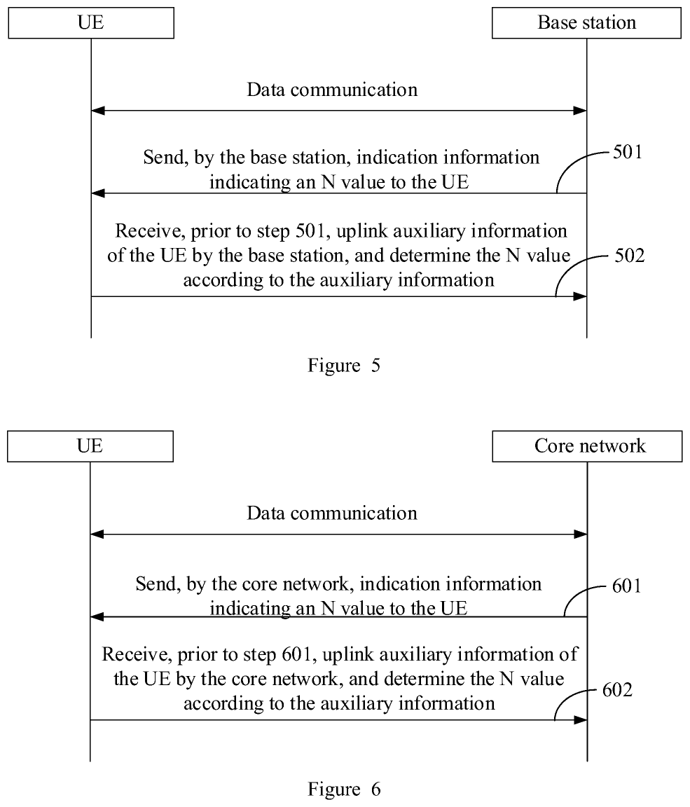

As shown in FIG. 5, the example provides a method for transmitting information, specifically including:

step 501: the base station sends indication information indicating an N value to UE, where the N value is the number of candidate positions of RAN PTW start point of a hyper frame. The N value may be 4, 6, or 8 or 16, etc.

In an example, the base station may send, for the single UE, for example, the indication information carried in an RRC message to the UE.

In an example, the base station may also send, for all the UE in a cell, for example, the indication information carried in a system message to the UE.

In some examples, the method for transmitting information further includes:

step 502: prior to the step 501, the base station may receive uplink auxiliary information of the UE, and determine the N value according to the auxiliary information. The auxiliary information may indicate the capacity, type and the like of the UE.

The UE will determine the RAN PTW according to the N value indicated by the base station, and an RAN paging message is monitored.

In response to determining that the UE does not receive the N value, the UE may be configured by default, for example 4, as the N value; or, the number of candidate positions of CN PTW start point of a hyper frame serves as the number of candidate positions of RAN PTW start point of a hyper frame.

In an example, the base station may further send the indication information indicating the N value to adjacent base station(s). Here, the base stations may be anchor base stations, and the adjacent base station(s) may be non-anchor base stations.

### Example 2

As shown in FIG. 6, the example provides a method for transmitting information, specifically including:

step 601: a core network sends indication information indicating an N value to UE, where the N value is the number of candidate positions of CN PTW start point of a hyper frame. The N value may be 4, 6, or 8 or 16, etc.

Specifically, the core network may directly send the indication information to the UE, for example, the indication information indicating the N value is carried in an NAS signaling and sent to the UE.

In some examples, the method for transmitting information further includes:

step 602: prior to the step 601, the core network may receive uplink auxiliary information of the UE, and determine the N value according to the auxiliary information. The auxiliary information may indicate the capacity, type and the like of the UE.

The UE will determine the CN PTW according to the N value indicated by the core network, and a CN paging message is monitored.

In response to determining that the UE does not receive the N value, the UE may be configured by default, for example 4, as the N value, and the CN PTW is determined.

In an example, the core network may further indicate the base station to send the indication information indicating the N value to the single UE. For example, the indication information indicating the N value is carried in the paging message and sent to the base station. Or the base station is informed in advance in an NG setup response message for subsequent paging scheduling.

As an example, the example 1 and the example 2 may work at different times.

As an example, the example 1 may be merely adopted, and the number of the candidate positions of CN PTW start point of the hyper frame follows existing agreement stipulates.

As an example, the example 2 may be merely adopted, and the number of the candidate positions of RAN PTW start point of the hyper frame follows existing agreement stipulates.

### Example 3

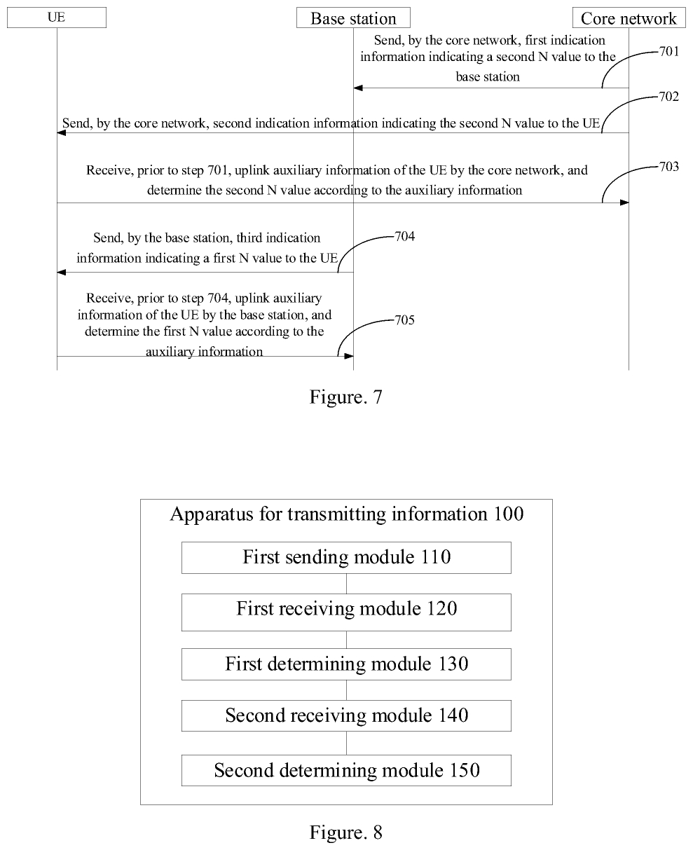

As shown in FIG. 7, the example provides a method for transmitting information, specifically including:

step 701: the core network sends first indication information indicating a second N value to a base station, where the N value is the number of candidate positions of CN PTW start point of a hyper frame. The N value may be 4, 6, or 8 or 16, etc. For example, the first indication information indicating the second N value is carried in a paging message and sent to the base station. Or the base station is informed in advance in an NG setup response message for subsequent paging scheduling.

Step 702: the core network sends second indication information indicating the second N value to UE, where the N value is the number of the candidate positions of CN PTW start point of the hyper frame. The N value may be 4, 6, or 8 or 16, etc.

In some examples, the method for transmitting information further includes:

step 703: prior to the step 701, the core network may receive uplink auxiliary information of the UE, and determine the second N value according to the auxiliary information. The auxiliary information may indicate the capacity, type and the like of the UE.

The UE will determine the CN PTW according to the second indication information indicating the second N value indicated by the core network, and a CN paging message is monitored.

In response to determining that the UE does not receive the second indication information indicating the second N value, the UE may be configured by default, for example 4, as the second N value, and the CN PTW is determined.

Step 704: the base station sends third indication information indicating a first N value to the UE, where the first N value is the number of candidate positions of RAN PTW start point of a hyper frame. The first N value may be 4, 6, or 8 or 16, etc.

In some examples, the method for transmitting information further includes:

step 705: prior to the step 704, the base station may receive the uplink auxiliary information of the UE, and determine the first N value according to the auxiliary information. The auxiliary information may indicate the capacity, type and the like of the UE.

The UE will determine the RAN PTW according to the third indication information indicating the first N value indicated by the base station, and an RAN paging message is monitored.

In response to determining that the UE does not receive the first N value, the UE may be configured by default, for example 4, as the first N value, and the RAN PTW is determined.

At an overlapping position of the RAN PTW and the CN PTW, monitoring of an RAN paging message and a CN paging message may be decided according to the CN PTW start point.

### Example 4

1, under an eDRX scene, an N value for determining a position of a PTW start point may be configured.

2, a base station may inform a terminal an N value for determining a position of an RAN PTW start point.
a) an informing way may be for the single UE or for the cell.
b) the N value may be 4, 8 or other values.
c) as an example: in response to determining that informing is performed for the single UE, an RRC release message may be used for informing.
d) as an example: in response to determining that informing is performed for the cell, a system message will be used for informing.
e) as an example: the N value is an optional parameter; and in response to determining that the base station does not provide the N value, the terminal processes according to a default configuration.

As an example, the default configuration of the N value is 4.

As an example, the default configuration of the N value is an N value issued from the core network and used to determine the position of the CN PTW start point.

3, the base station informs the terminal that the N value used to determine the position of the RAN PTW start point may be transmitted between base station nodes.
a) as an example: the parameter will be transmitted between an anchor base station and a non-anchor base station through the RAN paging message.

4, the terminal will monitor the RAN paging message according to the N value for the base station informing the terminal to determine the position of the RAN PTW start point.
a) as an example: at the moment, an overlapping part does not exist between the RAN PTW and the CN PTW. At the moment, an eDRX period TeDRX determined by calculating the RAN PTW start point may be a non-activated state eDRX period or an idle state eDRX period; that is, the position of the RAN PTW start point and the position of the CN PTW start point may not the same.

b) as an example: at the moment, an overlapping part exists between the RAN PTW and the CN PTW. At the moment, the CN PTW start point may serve as a paging message monitoring start point.

5, the terminal will provides auxiliary information to the base station, so that the base station informs the terminal to set the N value for determining the position of the RAN PTW start point.

6, the core network will inform the terminal/base station the determined N value for determining the position of the CN PTW start point.
a) the core network informs the terminal to adopt an NAS signaling.
b) the N value may be 4, 8 or other values.
c) the core network informs the base station that the informing way may be for the single UE or for the cell.
d) as an example: in response to determining that informing is performed for the single UE, the base station may be informed in the paging message.
e) as an example: in response to determining that informing is performed for the cell, the core network may inform the base station in an NG setup response message to the base station for subsequent scheduling use.
f) as an example: the N value is an optional parameter; and in response to determining that the core network does not provide the N value, the terminal/base station processes according to a default configuration.

As an example, the default configuration of the N value is 4.

7, the terminal will monitor the CN paging message according to the N value for the core network informing the terminal to determine the position of the CN PTW start point.
a) as an example: at the moment, an overlapping part may exist between an RAN PTW and a CN PTW, and monitoring of CN paging information and RAN paging information needs to be performed at the same time.

8, the terminal will provide the auxiliary information to the core network, so that the core network informs the terminal to determine setting of the N value for determining the position of the CN PTW start point.

An example of the disclosure further provides an apparatus for transmitting information, applied into a first base station of the cellular mobile wireless communication, and as shown in FIG. 8, the apparatus for transmitting information 100 includes:
a first sending module 110, configured to send indication information indicating an N value, where the N value is the number of candidate positions of PTW start point of a hyper frame.

In an example, the N value includes at least one of:
a first N value, being the number of candidate positions of radio access network (RAN) PTW start point of the hyper frame; or
a second N value, being the number of candidate positions of core network (CN) PTW start point of the hyper frame.

In an example, the first sending module 110 is specifically configured to at least one of:
send the indication information to user equipment (UE); or
send the indication information to a second base station, where the second base station includes adjacent base station(s) of the first base station.

In an example, the indication information is carried in a radio resource control (RRC) message or a system message.

In an example, the apparatus 100 further includes:
a first receiving module 120, configured to receive auxiliary information sent by the UE; and
a first determining module 130, configured to determine the N value based on the auxiliary information;
the auxiliary information includes:
first information for the first base station to determine the number of the candidate positions of RAN PTW start point of the hyper frame;
and/or,
second information for the core network to determine the number of the candidate positions of CN PTW start point of the hyper frame.

In an example, the indication information is carried in a radio access network paging message and sent to the second base station.

In an example, the apparatus 100 further includes:
a second receiving module 140, configured to receive the indication information indicating the number of the candidate positions of CN PTW start point of the hyper frame sent by the core network.

In an example, the apparatus 100 further includes:
a second determining module 150, configured to determine, in response to determining that the indication information indicating the number of the candidate positions of CN PTW start point of the hyper frame sent by the core network is not received, the number of the candidate positions of CN PTW start point of the hyper frame according to a first preset value.

In an example, the first sending module 110 is specifically configured to at least one of:
send, based on indication of the core network, the indication information for the single UE; or
send, based on the indication of the core network, the indication information for all the UE in a cell.

In an example, the first sending module 110 is specifically configured to:
send, in response to determining that the paging message carrying the indication information indicating the N value sent by the core network is received, the indication information to the UE paged by the paging message.

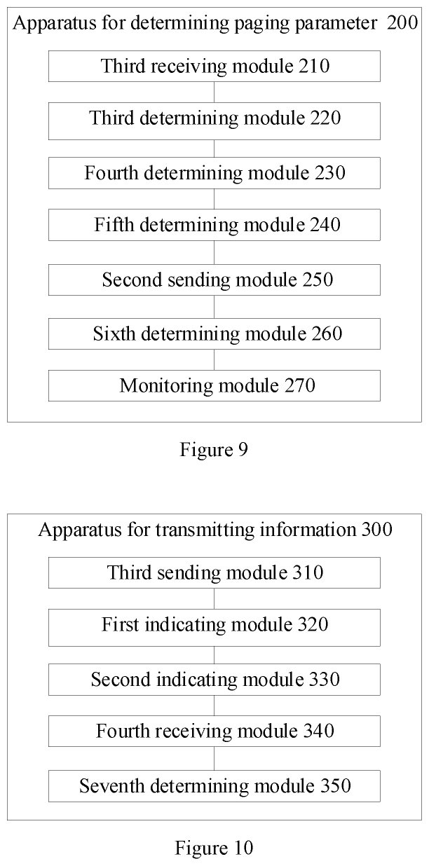

An example of the disclosure further provides an apparatus for determining paging parameter, applied into UE of cellular mobile wireless communication, and as shown in FIG. 9, the apparatus for determining paging parameter 200 includes:
a third receiving module 210, configured to receive indication information indicating an N value, where the N value is the number of candidate positions of PTW start point of a hyper frame.

In an example, the N value includes at least one of:
a first N value, being the number of candidate positions of radio access network (RAN) PTW start point of the hyper frame; or
a second N value, being the number of candidate positions of core network (CN) PTW start point of the hyper frame.

In an example, the third receiving module 210 is specifically configured to at least one of:
receive the indication information sent by a first base station; or
receive the indication information sent by a core network.

In an example, the indication information is carried in a radio resource control (RRC) message, a system message, a non-access-stratum (NAS) signaling, or a paging message.

In an example, the apparatus 200 may further include at least one of:
a third determining module 220, configured to determine, in response to determining that the indication information is not received, the number of the candidate positions of CN PTW start point of the hyper frame according to a first preset value;
a fourth determining module 230, configured to determine, in response to determining that the indication information is not received, the number of the candidate positions of RAN PTW start point of the hyper frame according to a second preset value; or
a fifth determining module 240, configured to determine, in response to determining that the indication information is not received, the number of the candidate positions of RAN PTW start point of the hyper frame according to the number of the candidate positions of CN PTW start point of the hyper frame.

In an example, the apparatus 200 further includes:
a second sending module 250, configured to send auxiliary information;
where the auxiliary information includes:

first information for the first base station to determine the number of the candidate positions of RAN PTW start point of the hyper frame;
and/or,
second information for the core network to determine the number of the candidate positions of CN PTW start point of the hyper frame.

In an example, the apparatus 200 further includes:
a sixth determining module 260, configured to determine a position of the RAN PTW start point according to the number of the candidate positions of RAN PTW start point of the hyper frame and a non-activated state eDRX period.

In an example, the apparatus 200 further includes:
a monitoring module 270, configured to monitor, within an overlapping time period of an RAN PTW and a CN PTW, an RAN paging message and a CN paging message.

An example of the disclosure further provides an apparatus for transmitting information, applied into a core network of cellular mobile wireless communication, and as shown in FIG. 10, the apparatus for transmitting information 300 includes:
a third sending module 310, configured to send indication information indicating an N value, where the N value is the number of candidate positions of core network (CN) PTW start point of a hyper frame.

In an example, the third sending module 310 is specifically configured to at least one of:
send the indication information to user equipment (UE); or
sending the indication information to a base station.

In an example, the apparatus 300 further includes at least one of:
a first indicating module 320, configured to indicate, in response to sending the indication information to the base station, the base station to send the indication information for the single UE; or
a second indicating module 330, configured to indicate, in response to sending the indication information to the base station, the base station to send the indication information for all the UE in a cell.

In an example, the first indicating module 320 is specifically configured to:
send a paging message for the UE to the base station, where the paging message carries the indication information.

In an example, the indication information is carried in a non-access-stratum (NAS) signaling, or the paging message.

In an example, the apparatus 300 further includes:
a fourth receiving module 340, configured to receive auxiliary information sent by the UE; and
a seventh determining module 350, configured to determine the N value based on the auxiliary information.

In an example, the first sending module 110, the first receiving module 120, the first determining module 130, the second receiving module 140, the second determining module 150, the third receiving module 210, the third determining module 220, the fourth determining module 230, the fifth determining module 240, the second sending module 250, the sixth determining module 260, the monitoring module 270, the third sending module 310, the first indicating module 320, the second indicating module 330, the fourth receiving module 340, the seventh determining module 350 and the like may be implemented by one or more central processing units (CPUs), graphics processing units (GPUs), baseband processors (BPs), application specific integrated circuits (ASICs), DSPs, programmable logic devices (PLDs), complex programmable logic devices (CPLDs), field-programmable gate arrays (FPGAs), general-purpose processors, controllers, micro controller unita (MCUs), microprocessors, or other electronic components, for executing the above-mentioned method.

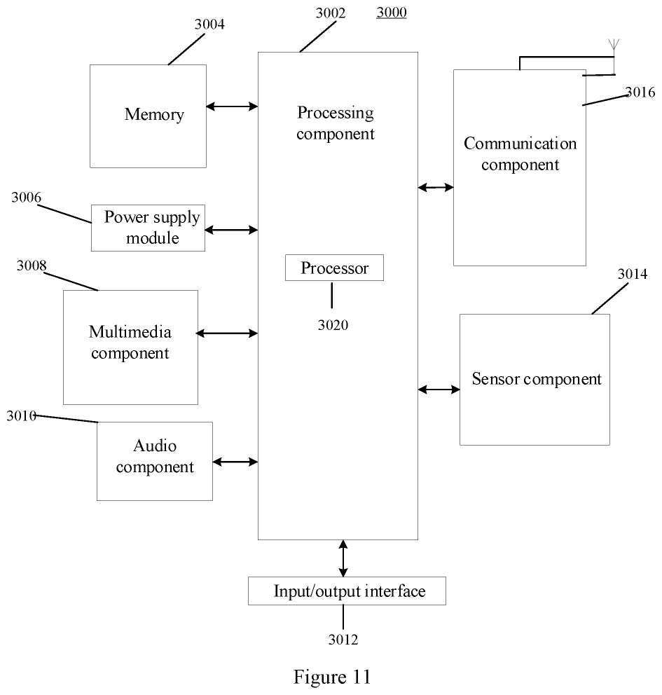

FIG. 11 is a block diagram of an apparatus 3000 for determining paging parameter or transmitting information shown according to an example. For example, the apparatus 3000 may be a mobile phone, a computer, a digital broadcast terminal, a message transceiver, a game console, a tablet device, a medical device, fitness equipment, a personal digital assistant and the like.

Referring to FIG. 11, the apparatus 3000 may include the following one or more components: a processing component 3002, a memory 3004, a power supply module 3006, a multimedia component 3008, an audio component 3010, an input/out (I/O) interface 3012, a sensor component 3014, and a communication component 3016.

The processing component 3002 usually controls integral operations of the apparatus 3000, such as operations related to display, phone call, data communication, camera operation and record operation. The processing component 3002 may include one or more processors 3020 to execute instructions, so as to complete all or part of steps of the above method. In addition, the processing component 3002 may include one or more modules, facilitating interaction between the processing component 3002 and other components. For example, the processing component 3002 may include a multimedia module, facilitating interaction between the multimedia component 3008 and the processing component 3002.

The memory 3004 is configured to store various types of data to support operations on the apparatus 3000. Examples of these data include instructions of any application program or method operated on the apparatus 3000, contact data, telephone directory data, messages, pictures, videos and the like. The memory 3004 may be implemented through any type of volatile or non-volatile storage devices or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply module 3006 provides power for various components of the apparatus 3000. The power supply module 3006 may include a power management system, one or more power sources, and other components associated with generation, management and electric power distribution of the apparatus 3000.

The multimedia component 3008 includes a screen providing an output interface between the apparatus 3000 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch the panel. The touch sensors may not only sense boundaries of touch or sliding actions, but also detect the duration and pressure associated with the touch or sliding actions. In some examples, the multimedia component 3008 includes a front-facing camera and/or a rear-facing camera. In response to determining that the apparatus 3000 is in an operation mode, such as a shooting mode or a video mode, the front-facing camera and/or the rear-facing camera may receive external multimedia data. Each front-facing camera and the rear-facing camera may be a fixed optical lens system or have focal length and optical zoom capacity.

The audio component 3010 is configured to output and/or input audio signals. For example, the audio component 3010 includes a microphone (MIC), and in response to determining that the apparatus 3000 is in the operation mode, such as a call mode, a record mode and a voice recognition mode, the microphone is configured to receive the external audio signals. The received audio signals may be further stored in the memory 3004 or sent by the communication component 3016. In some examples, the audio component 3010 further includes a loudspeaker for outputting the audio signals.

The I/O interface 3012 provides an interface between the processing component 3002 and a peripheral interface module, and the above peripheral interface module may be a keyboard, click wheels, buttons and the like. These buttons include but are not limited to: a homepage button, a volume button, a start button and a lock button.

The sensor component 3014 includes one or more sensors, and is used for providing state evaluation of all aspects for the apparatus 3000. For example, the sensor component 3014 may detect an opening/closing state of the apparatus 3000, and relative positioning of the components, for example, the components are a display and a keypad of the apparatus 3000, and the sensor component 3014 may further detect position changes of the apparatus 3000 or one component of the apparatus 3000, existence or inexistence of touch of the user and the apparatus 3000, orientation or accelerating/decelerating of the apparatus 3000 and temperature change of the apparatus 3000. The sensor component 3014 may include a proximity sensor, which is configured to detect the existence of nearby objects without any physical touch. The sensor component 3014 may further include an optical sensor, such as a CMOS or a CCD image sensor, which is used in imaging application. In some examples, the sensor component 3014 may further include an acceleration sensor, a gyroscope sensor, a magnetic sensor, a pressure sensor or a temperature sensor.

The communication component 3016 is configured to facilitate wired or wireless communication between the apparatus 3000 and other devices. The apparatus 3000 may be switched in a wireless network based on a communication standard, such as Wi-Fi, 2G or 3G, or their combination. In an example, the communication component 3016 receives broadcast signals or broadcast related information from an external broadcast management system through a broadcast channel. In an example, the communication component 3016 further includes a near-field communication (NFC) module to promote short-range communication. For example, the NFC module may be implemented based on the radio frequency identification (RFID) technology, an infrared data association (IrDA) technology, an ultra wide band (UWB) technology, a Bluetooth (BT) technology and other technologies.

In the example, the apparatus 3000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors or other electrical components to execute the above method.

In the example, a non-transitory computer readable storage medium including instructions is further provided, such as the memory 3004 including instructions, and the above instructions may be executed by the processor 3020 of the apparatus 3000 to complete the above method. For example, the non-transitory computer readable storage medium may be an ROM, a random access memory (RAM), a CD-ROM, a magnetic tape, a floppy disk, an optical data storage device and the like.

Those skilled in the art will easily think of other implementation solutions of the disclosure after considering the specification and practicing the disclosure disclosed here. The disclosure is intended to cover any variations, use or adaptation of the disclosure, these variations, use or adaptation conform to the general principles of the disclosure and include the common knowledge or customary technical means in the technical field not disclosed in the disclosure. The specification and the examples are examples.

It may be understood that the examples of the disclosure is not limited to the precise structure described above and shown in the accompanying drawings, and is subjected to various modifications and changes within the scope. The scope of the examples of the disclosure is limited by the appended claims.

1. A method for transmitting information, performed by a first base station, and comprising:
sending indication information indicating an N value, wherein the N value is a number of candidate positions of paging time window (PTW) start point of a hyper frame.

2. The method according to claim 1, wherein the N value comprises at least one of:
a first N value, being the number of candidate positions of radio access network (RAN) PTW start point of a hyper frame; or
a second N value, being the number of candidate positions of core network (CN) PTW start point of a hyper frame.

3. The method according to claim 1, wherein sending the indication information indicating the N value comprises at least one of:
sending the indication information to user equipment (UE); or
sending the indication information to a second base station, wherein the second base station comprises adjacent base station(s) of the first base station.

4. The method according to claim 3, wherein the indication information is carried in a radio resource control (RRC) message or a system message.

5. The method according to claim 3, further comprising:
receiving auxiliary information sent by the UE; and
determining the N value based on the auxiliary information;
wherein the auxiliary information comprises at least one of:
first information for the first base station to determine the number of the candidate positions of RAN PTW start point of a hyper frame;
or,
second information for a core network to determine the number of the candidate positions of CN PTW start point of a hyper frame.

6. (canceled)

7. The method according to claim 3, further comprising:
receiving the indication information indicating the number of the candidate positions of CN PTW start point of a hyper frame sent by a core network.

8. The method according to claim 7, further comprising:
determining, in response to determining that the indication information indicating the number of the candidate positions of CN PTW start point of the hyper frame sent by the core network is not received, the number of the candidate positions of CN PTW start point of the hyper frame according to a first preset value.

9. The method according to claim 3, wherein sending the indication information to the UE comprises at least one of:
sending, based on indication of a core network, the indication information for a single UE; or
sending, based on the indication of the core network, the indication information for all the UE in a cell.

10. (canceled)

11. A method for determining paging parameter, performed by user equipment (UE), and comprising:
receiving indication information indicating an N value, wherein the N value is a number of candidate positions of paging time window (PTW) start point of a hyper frame.

12. The method according to claim 11, wherein the N value comprises at least one of:
a first N value, being the number of candidate positions of radio access network (RAN) PTW start point of a hyper frame; or
a second N value, being the number of candidate positions of core network (CN) PTW start point of a hyper frame.

13. The method according to claim 11, wherein receiving the indication information indicating the N value comprises at least one of:
receiving the indication information sent by a first base station; or
receiving the indication information sent by a core network.

14. The method according to claim 13, wherein the indication information is carried in a radio resource control (RRC) message, a system message, a non-access-stratum (NAS) signaling, or a paging message.

15. The method according to claim 13, further comprising at least one of:
determining, in response to determining that the indication information is not received, the number of the candidate positions of CN PTW start point of a hyper frame according to a first preset value;
determining, in response to determining that the indication information is not received, the number of the candidate positions of RAN PTW start point of a hyper frame according to a second preset value;
determining, in response to determining that the indication information is not received, the number of the candidate positions of RAN PTW start point of the hyper frame according to the number of the candidate positions of CN PTW start point of the hyper frame;
sending auxiliary information; wherein the auxiliary information comprises at least one of: first information for the first base station to determine the number of the candidate positions of RAN PTW start point of the hyper frame; or, second information for the core network to determine the number of the candidate positions of CN PTW start point of the hyper frame;
determining a position of an RAN PTW start point according to the number of the candidate positions of RAN PTW start point of the hyper frame and a non-activated state eDRX period; or
monitoring, within an overlapping time period of an RAN PTW and a CN PTW, an RAN paging message and a CN paging message.

16.-18. (canceled)

19. A method for transmitting information, performed by a core network, and comprising:
sending indication information indicating an N value, wherein the N value is a number of candidate positions of core network paging time window (CN PTW) start point of a hyper frame.

20. The method according to claim 19, wherein sending the indication information indicating the N value comprises at least one of:
sending the indication information to user equipment (UE); or
sending the indication information to a base station.

21. The method according to claim 20, further comprising at least one of:
indicating, in response to sending the indication information to the base station, the base station to send the indication information for a single UE; or
indicating, in response to sending the indication information to the base station, the base station to send the indication information for all the UE in a cell.

22.-23. (canceled)

24. The method according to claim 19, further comprising:
receiving auxiliary information sent by UE; and
determining the N value based on the auxiliary information.

25. (canceled)

26. An apparatus for-use in UE, the apparatus comprising:
one or more processors; and
a memory configured to store an instruction executable by the processor;
wherein the one or more processors are collectively configured to load and execute the instruction, wherein the instruction causes the one or more processors to collectively execute the method for determining paging parameter according to claim 11.

27. (canceled)

28. A communication device for use in a first base station, the communication device comprising
one or more processors;
a memory; and
an executable program stored on the memory;
wherein the executable program when executed by the one or more processors cause the one or more processors to collectively execute the method for transmitting information according to claim 1.

29. A non-transitory computer-readable storage medium, storing an executable program, wherein the executable program, when executed by a processor, implements steps of the method for transmitting information according to claim 1.
